(19) United States
(12) Patent Application Publication
(10) Pub. No.: US 2026/0043273 A1
(43) Pub. Date: Feb. 12, 2026

(54) DOOR HANDLE LIMITER

(71) Applicants: HAO-WEI YANG, Changhua County (TW); TZU-YI YANG, Changhua County (TW)

(72) Inventors: HAO-WEI YANG, Changhua County (TW); TZU-YI YANG, Changhua County (TW)

(21) Appl. No.: 18/796,313

(22) Filed: Aug. 7, 2024

(51) Int. Cl. E05B 61/00

(52) U.S. Cl. CPC E05B 61/00

(57) ABSTRACT

A door handle limiter includes a latch component including a latch part, a lock hook, and a chain. The chain has a first end thereof connected to the latch component, and a second end of the chain is connected to the lock hook. The user simply needs to hook the lock hook onto the chain of the door chain lock and then latch the latch component onto the end of the inner door handle. This prevents the door handle from being pushed down.

### FIELD OF THE INVENTION

The present invention relates to a door handle limiter, and more particularly, to a door handle limiter connected the chain lock of the door and the door handle to secure the door handle and prevent outsiders from turning the handle from the outside.

### BACKGROUND OF THE INVENTION

Locks are essential products for every household in today's society. They serve the function of preventing outsiders from opening doors and invading interiors, thereby protecting household property, ensuring personal safety, and preventing intrusions. Additionally, locks enhance the anti-theft capability of storage devices that hold valuable items, such as secondary locks for safes, luggage locks, airport locks, and spare key lockboxes, among others.

Besides the aforementioned locks, there are many types of locks used on doors. Among them, door chain locks are commonly used in hotels and residences. The structure of a door chain lock includes one end installed on the door frame and the other end of the door chain lock is freely attached to the door, along with a chain. The key characteristic of this type of lock is that it does not have a key and can only be locked from the inside, making it commonly used as a secondary lock.

However, despite the convenience and effectiveness of the aforementioned door chain locks, there are still security shortcomings.

Due to their structural characteristics, they cannot restrict the use of the door handle. Therefore, when the door chain lock is engaged, it cannot prevent the door from being opened, it can only limit the extent to which the door can be opened.

The present invention intends to provide a door handle limiter to eliminate the shortcomings mentioned above.

### SUMMARY OF THE INVENTION

The present invention relates to a door handle limiter and comprises a latch component including a latch part, a lock hook, and a chain. The chain has a first end thereof connected to the latch component, and a second end of the chain connected to the lock hook.

Preferably, the latch part of the latch component has a groove.

Preferably, the latch component has a connecting hole defined through a top thereof. The first end of the chain is connected to the connecting hole of the latch component.

Preferably, the lock hook includes a main body which has a hook opening, and a closure rod with one end pivotally and resiliently connected to one end of the hook opening. The closure rod is resiliently pivoted to open and close the hook opening.

The primary object of the present invention is to provide a door handle limiter that is used in conjunction with a door chain lock. The main structure includes a latch component and a lock hook, with a chain connected between the lock hook and the latch component. In actual use, the user simply needs to hook the lock hook of the present invention onto the chain of the door chain lock and then latch the latch component onto the inner door handle. This prevents the door handle from being pushed down. Therefore, the user only needs to install the present invention on the chain of a traditional door chain lock to effectively solve the issue of traditional door chain locks not being able to restrict the use of the door handle.

The present invention provides a door handle limiter that can be used with a door chain lock. The main structure includes a latch component and a lock hook, connected by a chain. In practical use, the user simply needs to hook the lock hook of the present invention onto the chain of the door chain lock and then latch the latch component onto the end of the inner door handle. This prevents the door handle from being pushed down. Therefore, the user only needs to install the present invention on the chain of a traditional door chain lock to effectively solve the problem of traditional door chain locks not being able to restrict the use of the door handle. The present invention is indeed novel and progressive.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the door handle limiter of the present invention;

FIG. 2 illustrates the present invention in actual use, and

FIG. 3 is a cross-sectional view, taken along line III-III of FIG. 2.

### DETAILED DESCRIPTION OF THE PREFERRED EMBODIMENT

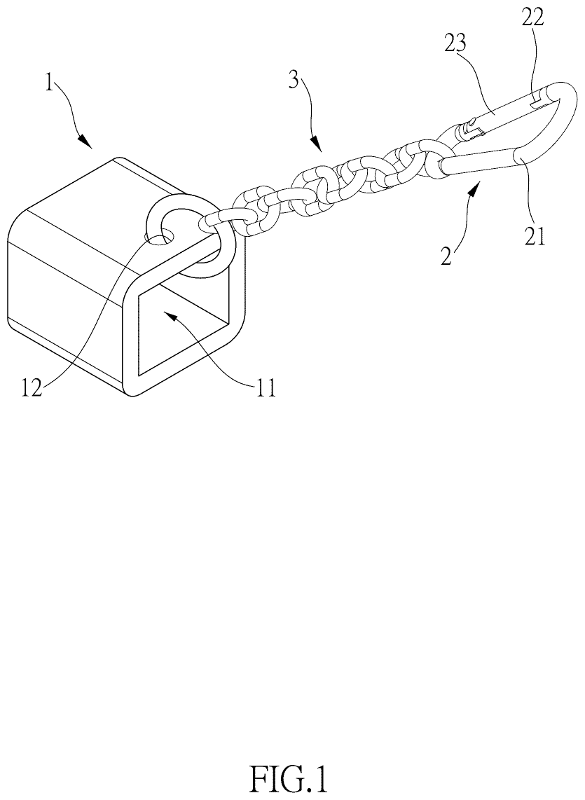

Referring to FIG. 1, the door handle limiter of the present invention comprises a latch component (1) including a latch part (11), a lock hook (2), and a chain (3) having a first end thereof connected to the latch component (1), and a second end of the chain (3) connected to the lock hook (2).

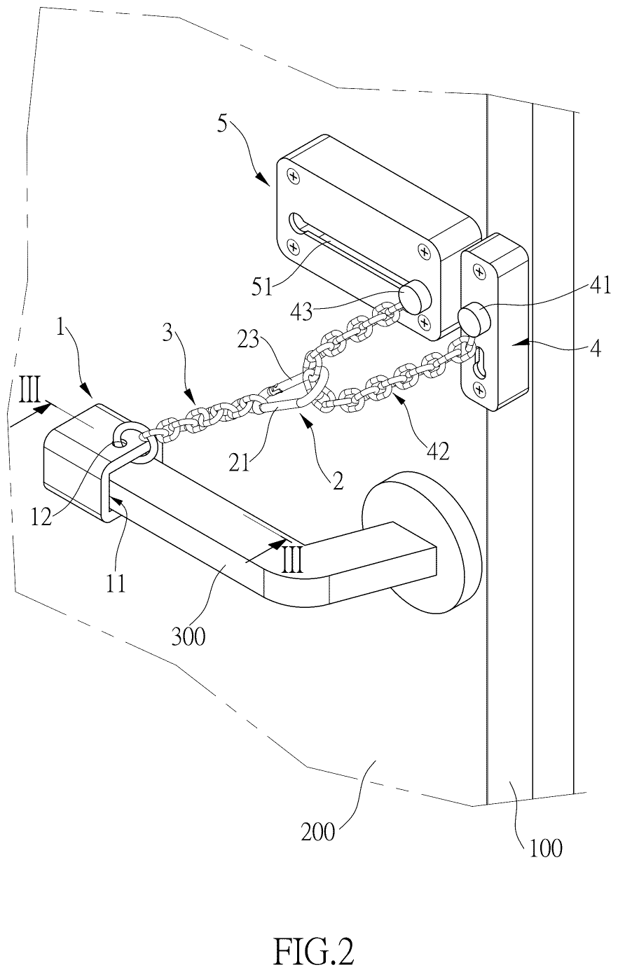

As shown in FIG. 2, a door chain lock generally includes a frame-side component (4) which includes a chain attachment part (41). When in actual use, the frame-side component (4) is installed on the door frame (100), and the chain attachment part (41) is connected to a movable latch (43) via a chain (42). The door chain lock also includes a door-side component (5), which is installed on the door panel (200). The door-side component (5) includes a slide rail (51). The user only needs to slide the movable latch (43) into the slide rail (51) to lock the door chain lock. However, it is clear from the illustration that the door chain lock does not restrict the door handle in any way, relying solely on the length of the chain (42) to limit the opening angle of the door panel (200) to prevent outsider intrusion. Therefore, the security of the door chain lock is somewhat lacking.

In order to address the problem of traditional door chain locks being unable to restrict the use of the door panel (200) door handle, the present invention provides a door handle limiter that can be used with a door chain lock. The main structure includes a latch component (1) and a lock hook (2), with a chain (3) connecting the lock hook (2) and the latch component (1). In actual use, the user simply needs to hook the lock hook (2) of the present invention onto the chain (42) of the door chain lock. Then, as shown in FIG. 2, the latch component (1) is latched onto the distal end of the inner door handle (300), preventing the door handle (300) from being pushed down. Thus, it is clear that the user only needs to install this invention on the chain (42) of a traditional door chain lock to effectively solve the problem of traditional door chain locks being unable to restrict the use of the door handle (300).

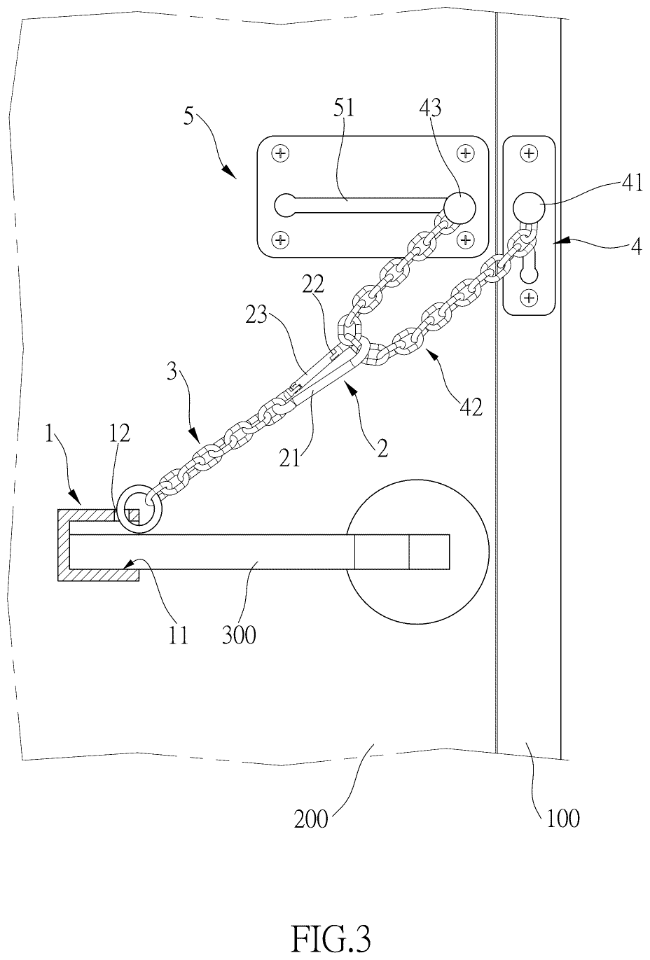

As shown in FIGS. 1 and 3, the latch part (11) of the latch component (1) has a grooved shape. This embodiment provides a detailed structure of the latch component (1) that can indeed latch onto the distal end of the door handle (300). This structure makes the latch component (1) more stable when latched onto the distal end of the door handle (300) and prevents the latch component (1) from sliding freely on the door handle (300).

As shown in FIGS. 1 and 3, the top of the latch component (1) has a connecting hole (12). One end of the chain (3) is connected to the latch component (1) through this connecting hole (12). This embodiment provides a detailed structure of the connection between the latch component (1) and the chain (3), making the connection more stable.

The lock hook (2) comprises a main body (21) with a hook opening (22). Additionally, a closure rod (23) is pivotally and resiliently installed at one end of the hook opening (22), with the pivot point having a reset structure. The closure rod (23) can move to open and close the hook opening (22). This structure allows users to install the invention on the chain (42) of the door chain lock more easily and effortlessly.

While we have shown and described the embodiment in accordance with the present invention, it should be clear to those skilled in the art that further embodiments may be made without departing from the scope of the present invention.

What is claimed is:

1. A door handle limiter comprising:
a latch component (1) including a latch part (11);
a lock hook (2), and
a chain (3) having a first end thereof connected to the latch component (1), and a second end of the chain (3) connected to the lock hook (2).

2. The door handle limiter as defined in claim 1, wherein the latch part (11) of the latch component (1) has a groove.

3. The door handle limiter as defined in claim 1, wherein the latch component (1) has a connecting hole (12) defined through a top thereof, the first end of the chain (3) is connected to the connecting hole (12) of the latch component (1).

4. The door handle limiter as defined in claim 1, wherein the lock hook (2) includes a main body (21) which has a hook opening (22), and a closure rod (23) with one end pivotally and resiliently connected to one end of the hook opening (22), the closure rod (23) is resiliently pivoted to open and close the hook opening (22).
